(19) United States
(12) Patent Application Publication
(10) Pub. No.: US 2025/0299437 A1
(43) Pub. Date: Sep. 25, 2025

(54) SYSTEM AND METHOD FOR IMPROVING RENDERING TECHNIQUES IN VIRTUAL REALITY SPACE

(71) Applicant: Tend VR Ltd, London (GB)

(72) Inventor: Matthew David Hoad-Robson, London (GB)

(73) Assignee: Tend VR Ltd, London (GB)

(21) Appl. No.: 18/611,102

(22) Filed: Mar. 20, 2024

(51) Int. Cl. G06T 15/80; G06T 15/04; G06T 15/60; G06T 19/20

(52) U.S. Cl. CPC G06T 15/80; G06T 15/04; G06T 15/60; G06T 19/20; G06T 2219/2016

(57) ABSTRACT

A system and method for rendering a stereoscopic virtual reality environment is presented. The method includes: receiving a digital three dimensional environment, the digital three dimensional environment including a plurality of graphic objects; selecting a first location in the digital three dimensional environment, the first location represented by a set of unique coordinates; determining a first spherical projection plane from the first location; pre-rendering a first object of the plurality of graphic objects on the first spherical projection plane; rendering in real-time a second object of the plurality of graphic; and updating a framebuffer with the second object and the first object, based on a shader output.

### TECHNICAL FIELD

The present disclosure relates generally to 2- and 3-D computer graphics and specifically to rendering 2- and 3-D graphical assets in virtual reality.

### BACKGROUND

The rendering of objects in virtual space is a computationally intensive problem fundamentally limited by hardware bottlenecks present in virtual reality (VR) hardware.

To overcome some of these hardware derived limitations, VR graphics developers have developed and utilized a number of modeling techniques to reduce the render time of 2- and 3-D objects prior to rendering and to improve overall render times.

While these techniques have yielded moderate gains in performance, they nevertheless fail to bring VR hardware to a performance standard sufficient to accurately recreate highly complex scenes in VR, which include multiple objects, scenery, etc.

This is fundamentally due to the nature of the current state of the art; objects rendered in VR space are done so in a manner that enables real time interaction from the VR user and are thus rendered in real time, often all at the same time.

This real time rendering requirement acts as a performance bottleneck when compounded with the hardware limitations inherent in VR products—a consequence of intended method of use & the formfactor limitations that come with it—and severely limits the potential capabilities of VR platforms.

It would therefore be advantageous to provide a solution that would overcome the challenges noted above.

### SUMMARY

A summary of several example embodiments of the disclosure follows. This summary is provided for the convenience of the reader to provide a basic understanding of such embodiments and does not wholly define the breadth of the disclosure. This summary is not an extensive overview of all contemplated embodiments, and is intended to neither identify key or critical elements of all embodiments nor to delineate the scope of any or all aspects. Its sole purpose is to present some concepts of one or more embodiments in a simplified form as a prelude to the more detailed description that is presented later. For convenience, the term “some embodiments” or “certain embodiments” may be used herein to refer to a single embodiment or multiple embodiments of the disclosure.

A system of one or more computers can be configured to perform particular operations or actions by virtue of having software, firmware, hardware, or a combination of them installed on the system that in operation causes or cause the system to perform the actions. One or more computer programs can be configured to perform particular operations or actions by virtue of including instructions that, when executed by data processing apparatus, cause the apparatus to perform the actions.

In one general aspect, method may include receiving a digital three dimensional environment, the digital three dimensional environment including a plurality of graphic objects. Method may also include selecting a first location in the digital three dimensional environment, the first location represented by a set of unique coordinates. Method may furthermore include determining a first spherical projection plane from the first location. Method may in addition include pre-rendering a first object of the plurality of graphic objects on the first spherical projection plane. Method may moreover include rendering in real-time a second object of the plurality of graphic; and updating a framebuffer with the second object and the first object, based on a shader output. Other embodiments of this aspect include corresponding computer systems, apparatus, and computer programs recorded on one or more computer storage devices, each configured to perform the actions of the methods.

Implementations may include one or more of the following features. Method may include: determining a second spherical projection plane from the first location, where the second spherical projection plane is closer than the first spherical projection to the first location; and rendering a third object on the second spherical projection plane. Method may include: pre-rendering the first object as a texture map projected onto the first spherical projection plane. Method may include: providing depth information of the second object to a shader processing circuitry; and configuring the shader processing circuitry to determine occlusion of the second object based on depth information of the first spherical projection plane. Method may include: providing depth information of the second object to a shader processing circuitry; and configuring the shader processing circuitry to determine a shadow of the second object based on depth information of the first spherical projection plane. Method may include: determining a third spherical projection plane between the first spherical projection plane and a second spherical projection plane; rendering in real-time a third object of the plurality of graphic objects; configuring a shader processing circuitry to determine a second shader output based on the third object, the second object, the first object; and updating the framebuffer based on the second shader output. Method may include: generating a composite rendered scene from the totality of objects rendered in each of the three spherical projection planes. Method may include: rotating the composite rendered environment around the first location, in real-time. Method may include: determining a plurality of third spherical projection planes; and rendering at least an object of the plurality of graphic objects on a spherical projection plane of the plurality of third spherical projection planes. Implementations of the described techniques may include hardware, a method or process, or a computer tangible medium.

In one general aspect, non-transitory computer-readable medium may include one or more instructions that, when executed by one or more processors of a device, cause the device to: receive a digital three dimensional environment, the digital three dimensional environment including a plurality of graphic objects; select a first location in the digital three dimensional environment, the first location represented by a set of unique coordinates; determine a first spherical projection plane from the first location; pre-render a first object of the plurality of graphic objects on the first spherical projection plane; render in real-time a second object of the plurality of graphic; and update a framebuffer with the second object and the first object, based on a shader output. Other embodiments of this aspect include corresponding computer systems, apparatus, and computer programs recorded on one or more computer storage devices, each configured to perform the actions of the methods.

In one general aspect, system may include a processing circuitry. System may also include a memory, the memory containing instructions that, when executed by the processing circuitry, configure the system to: receive a digital three dimensional environment, the digital three dimensional environment including a plurality of graphic objects. System may in addition select a first location in the digital three dimensional environment, the first location represented by a set of unique coordinates. System may moreover determine a first spherical projection plane from the first location. System may also pre-render a first object of the plurality of graphic objects on the first spherical projection plane. System may furthermore render in real-time a second object of the plurality of graphic. System may in addition update a framebuffer with the second object and the first object, based on a shader output. Other embodiments of this aspect include corresponding computer systems, apparatus, and computer programs recorded on one or more computer storage devices, each configured to perform the actions of the methods.

Implementations may include one or more of the following features. System where the memory contains further instructions which when executed by the processing circuitry further configure the system to: determine a second spherical projection plane from the first location, where the second spherical projection plane is closer than the first spherical projection to the first location; and render a third object on the second spherical projection plane. System where the memory contains further instructions which when executed by the processing circuitry further configure the system to: pre-render the first object as a texture map projected onto the first spherical projection plane. System where the memory contains further instructions which when executed by the processing circuitry further configure the system to: provide depth information of the second object to a shader processing circuitry; and configure the shader processing circuitry to determine occlusion of the second object based on depth information of the first spherical projection plane. System where the memory contains further instructions which when executed by the processing circuitry further configure the system to: provide depth information of the second object to a shader processing circuitry; and configure the shader processing circuitry to determine a shadow of the second object based on depth information of the first spherical projection plane. System where the memory contains further instructions which when executed by the processing circuitry further configure the system to: determine a third spherical projection plane between the first spherical projection plane and a second spherical projection plane; render in real-time a third object of the plurality of graphic objects; configure a shader processing circuitry to determine a second shader output based on the third object, the second object, the first object; and update the framebuffer based on the second shader output. System where the memory contains further instructions which when executed by the processing circuitry further configure the system to: generate a composite rendered scene from the totality of objects rendered in each of the three spherical projection planes. System where the memory contains further instructions which when executed by the processing circuitry further configure the system to: rotate the composite rendered environment around the first location, in real-time. System where the memory contains further instructions which when executed by the processing circuitry further configure the system to: determine a plurality of third spherical projection planes; and render at least an object of the plurality of graphic objects on a spherical projection plane of the plurality of third spherical projection planes. Implementations of the described techniques may include hardware, a method or process, or a computer tangible medium.

### BRIEF DESCRIPTION OF THE DRAWINGS

The subject matter disclosed herein is particularly pointed out and distinctly claimed in the claims at the conclusion of the specification. The foregoing and other objects, features, and advantages of the disclosed embodiments will be apparent from the following detailed description taken in conjunction with the accompanying drawings.

FIG. 1 is a graphical representation of a virtual reality image space, utilized to describe an embodiment.

FIG. 2 is an example flowchart of a method for rendering a virtual environment including objects and a background, implemented in accordance with an embodiment.

FIG. 3 is an example schematic diagram of a graphical processing unit (GPU) pipeline for rendering a virtual reality scene, utilized to describe an embodiment.

FIG. 4 is an example schematic diagram for a system according to an embodiment.

### DETAILED DESCRIPTION

It is important to note that the embodiments disclosed herein are only examples of the many advantageous uses of the innovative teachings herein. In general, statements made in the specification of the present application do not necessarily limit any of the various claimed embodiments. Moreover, some statements may apply to some inventive features but not to others. In general, unless otherwise indicated, singular elements may be in plural and vice versa with no loss of generality. In the drawings, like numerals refer to like parts through several views.

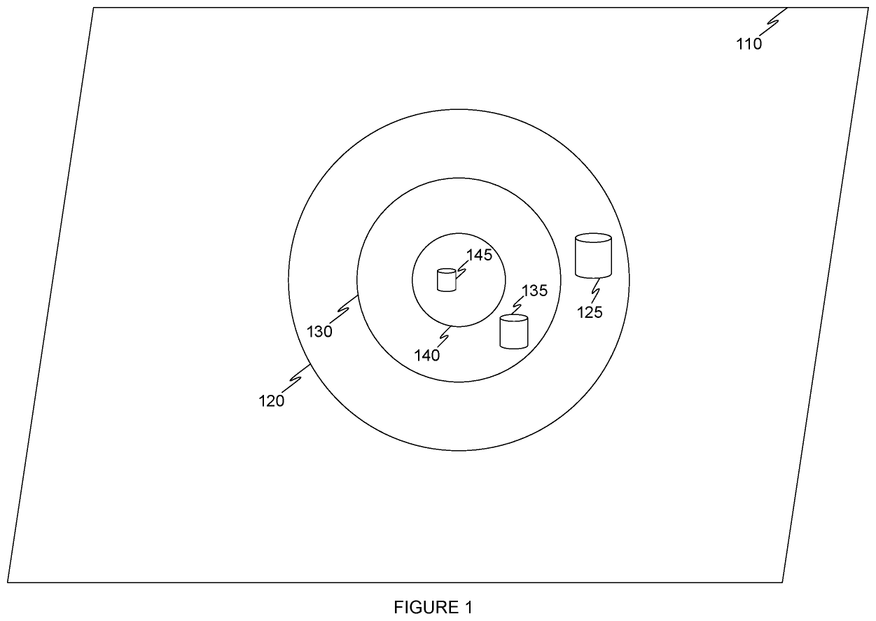

FIG. 1 is a graphical representation of a virtual reality image space 110, utilized to describe an embodiment. According to an embodiment, virtual reality environments are utilized to create an immersive user experience, including an illusion of three dimensional space. In order to create an immersive experience, it is advantageous to occlude a user's vision to anything other than the image being projected, as much as possible. This is often the case, in an embodiment, for virtual reality headsets, such as Meta® Quest®, Sony® Vive®, Apple® Vision Pro, and the like. In other embodiments, the teachings herein can be applied to augmented reality platforms, such as the Magic Leap®.

In certain embodiments, a virtual reality space is rendered on a display, a plurality of displays, and the like. For example, according to an embodiment, a virtual reality space is rendered by rendering a first stereoscopic image on a first display corresponding to a first eye, and rendering a second stereoscopic image on a second display corresponding to a second eye. In some embodiments, a single display is utilized, having display portions, such that an eye is directed to view one display portion, while a second display portion is occluded from the same eye.

In an embodiment, generating a stereoscopic display provides an illusion of three dimensional depth of a rendered environment. This is advantageous as it provides a user with an immersive experience. In an embodiment, it is further advantageous to improve the illusion, for example by improving the realism of rendering of the environment, thereby increasing the believability of the experience for the user.

In an embodiment, a 3D scene 110 includes a plurality of objects for rendering, such as a first object 125, a second object 135, and a third object 145. In an embodiment, an object includes depth data, a 3D model, a position in the 3D scene 110, a texture, a combination thereof, and the like.

According to an embodiment, a plurality of spherical captures are determined. In an embodiment, a spherical capture is a data record which includes a distance, radius, and the like, from a center point, such as a user position in the 3D scene 110. For example, in an embodiment, an outer spherical capture 120, a middle spherical capture 130, and an inner spherical capture 140 are generated. In some embodiments, a plurality of middle spherical captures 130 are generated, each having a unique distance, radius, and the like, from the center point.

In an embodiment, each of the plurality of objects is assigned a spherical capture. In some embodiments, an object is projected on the spherical capture to generate a spherical object. For example, in an embodiment, the first spherical object 125 is projected on the first spherical capture 120.

In some embodiments, a distance between each object and the center point is determined. In certain embodiments, an object is associated with a spherical capture based on the determined distance. For example, in an embodiment, the first object 125 is projected onto the first spherical capture 120, the second object 135 is projected onto the second spherical capture 130, and the third object 145 is projected onto the third spherical capture 140.

In some embodiments, a first distance is determined between the center point and the object, and a second distance is determined between the object and the surface of a spherical capture. In an embodiment, projecting an object on a spherical capture includes applying a transformation to a 3D model of the object. In some embodiments, the transformation is based on coordinates of the spherical capture, coordinates of the 3D object, a combination thereof, and the like.

In certain embodiments, a plurality of backgrounds are rendered as spherical projections. For example, in an embodiment, an image, a texture, and the like, are projected onto a spherical capture, such as the first spherical capture 120. According to an embodiment, the spherical captures are rendered such that an object projected on an inner spherical capture 140 occludes an object projected on an outer spherical capture, such as outer spherical capture 120 and middle spherical capture 130.

In an embodiment, the first spherical projection is rendered at a first resolution, a second spherical projection is rendered at a second resolution, etc. In some embodiments, the first resolution is less than the second resolution.

In some embodiments, the second spherical projection includes objects which are ‘closer’ to a viewpoint of a user than the first spherical projection. In certain embodiments, it is advantageous to pre-render a first spherical projection and store such a pre-rendering in a memory accessible to a graphical processor unit, such as a scratchpad memory.

In some embodiments, a scene is rendered based on a plurality of spherical projections, each spherical projection defined by a spherical capture having a fixed distance from a user coordinate. In certain embodiments, objects on a first spherical projection are pre-rendered, while objects on a second spherical projection are rendered in run-time. While spherical projections are discussed herein, it is evident other planar projections are utilized in other embodiments, combinations of other planar projections, and the like, can be utilized, without departing from the scope of this disclosure.

In certain embodiments, an object includes a texture, an animated texture, a combination thereof, and the like. In certain embodiments, a depth pass is performed to determine if a real-time rendered object occludes a pre-rendered object (e.g., based on a comparison of z-values relative to the center point) or a pre-rendered object occludes a real-time rendered object.

According to an embodiment, a shadow is projected onto an object during rendering. For example, in an embodiment, a shadow is determined based on an object projected onto a first spherical capture, and applied to an objected projected on a second spherical capture or a shadow is applied to a real-time rendered object from a spherical capture

In an embodiment, a plurality of objects are rendered, each on a spherical projection. In some embodiments, some objects are two-dimensional in appearance (i.e., flat objects), while other objects are three-dimensional.

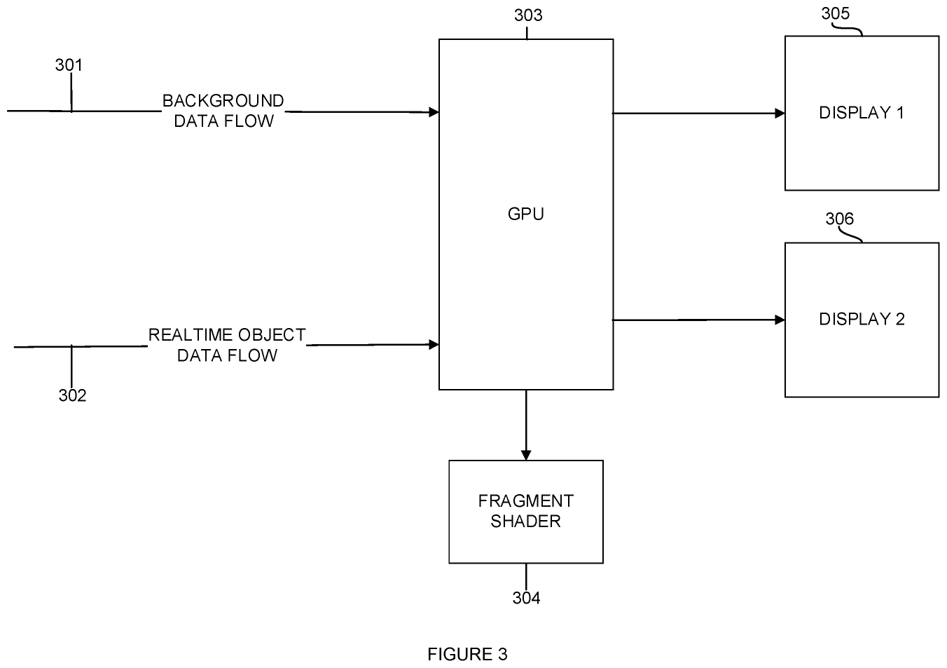

In an embodiment, certain objects, such as three dimensional objects, cast a shadow, for example on a background, on another object, a combination thereof, and the like, which is projected on a spherical capture. In some embodiments, blending the shadow is performed by an fragment shader, discussed in more detail in FIG. 3 below.

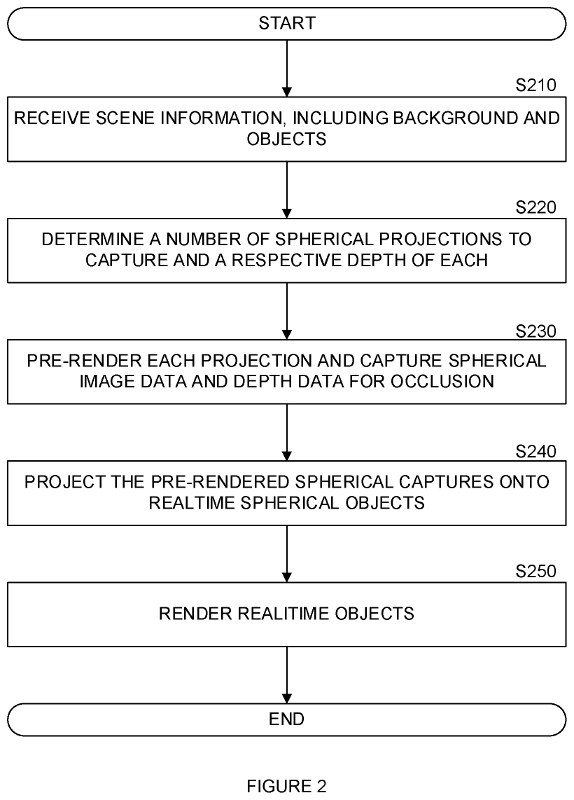

FIG. 2 is an example flowchart of a method for rendering a virtual environment including objects and a background, implemented in accordance with an embodiment.

At S210, scene information is received. In an embodiment, scene information includes a background and an object. In an embodiment, a background is a digital image. In some embodiments, the background is pre-rendered and projected on a first spherical plane. In certain embodiments, an object is rendered as projected on a second spherical plane, wherein the second spherical plane is closer to a user viewpoint than the first spherical plane.

In some embodiments, the scene information includes a background, and a plurality of objects, each object having a 3D model, a texture, a location, a distance from a center point, a combination thereof, and the like.

In an embodiment, a user viewpoint is defined by relative coordinates, such that a spherical plane is defined as any point at a fixed distance ‘R’ in a three dimensional space from the user viewpoint, where the user viewpoint is determined by a vector of three dimensions. In certain embodiments, the user viewpoint is further defined by an orientation. In an embodiment, orientation is represented utilizing a quaternion, Euler angles, a rotational representation, a combination thereof, and the like.

In some embodiments, scene information is stored in a memory, in a storage, in a buffer, a combination thereof, and the like. In certain embodiments, the scene information is accessible by a processor utilized to perform the methods described in more detail herein.

At S220, a number of spherical projection planes is determined. In an embodiment, a plurality of spherical projection planes includes a first spherical projection plane (e.g., a background sphere), a second spherical projection plane (e.g., an object sphere), a combination thereof, and the like. In an embodiment, each spherical projection plane (or surface) is a predetermined distance from a center point, which is the viewpoint of the scene from a user's perspective. For example, in an embodiment, a first spherical projection plane corresponds to the outer spherical capture 120, a second spherical projection plane corresponds to the middle spherical capture 130, and a third spherical projection plane corresponds to the inner spherical capture 140.

In some embodiments, a plurality of objects are selected for rendering. In certain embodiments, a number of spherical projections is predetermined, and each object of the plurality of objects is assigned to a spherical projection plane of a plurality of spherical projection planes. For example, in certain embodiments, a distance is determined between a first spherical projection plane and a location of a first object, and a second spherical projection plane and the location of the first object.

In an embodiment, a spherical projection plane is selected for the first object based on the determined distance between the first object and the spherical projection plane, such that the distance is a minimal distance (i.e., the spherical projection which is closest to the first object). In some embodiments, an object which is between two spherical projection planes is assigned to the exterior spherical projection plane, i.e., the spherical projection plane which is further away from the center point.

In an embodiment, each spherical projection is centered at a viewpoint of the user. In some embodiments spherical projection planes are determined such that a first spherical projection plane does not intersect with a second spherical projection plane.

At S230, the background is pre-rendered. In an embodiment, the background is pre-rendered on a background sphere. In some embodiments, a pre-rendered background is stored in a scratchpad memory, a buffer, and the like.

In certain embodiments, pre-rendering the background allows to render the background in a high resolution, as this avoids having to render the background in real time, as a user moves through the virtual reality scene, as the user shifts viewpoints in the virtual reality scene, etc.

In an embodiment, shifting a viewpoint includes changing a viewing plane while maintaining a position in the virtual reality scene. In some embodiments, a plurality of spherical projection planes are pre-rendered. In certain embodiments, a first spherical projection plane is prerendered, and a second spherical projection plane is rendered in real time. According to an embodiment, a real-time object is rendered in real time on a spherical projection plane.

At S240, an object is rendered on an object sphere. In an embodiment, the object is rendered in real time, while the background is pre-rendered. In certain embodiments, some objects are pre-rendered, with some object effects being rendered in real time. In some embodiments, a rendered object and a pre-rendered background are blended, for example using an occlusion shader. In an embodiment, a depth test is performed, to determine if the object is closer to the center point than another object, the background, a combination thereof, and the like. In some embodiments, an occlusion shader is configured to determine occlusion of a first object based on a first coordinate set, and a second object, based on a second coordinate set. In an embodiment, the coordinate set includes a ‘z’ coordinate in three-dimensional space.

For example, in an embodiment, an object is a first digital image, and an effect is a shadow projection. Rendering in this fashion is advantageous in an embodiment, as the first digital image does not change when a user shifts their viewpoint (or changes very little, in certain embodiments), while the shadow (e.g., the object effect) changes rapidly and therefore requires real-time rendering.

In some embodiments, a shadow is projected from a first object on a second object, on a background, projected onto a realtime object, on a combination thereof, and the like. In an embodiment, the first object is projected onto a first spherical capture, and the second object, the background, and the like, are projected onto a second spherical capture, or a realtime object. In an embodiment, the first spherical capture is internal to the second spherical capture, i.e., the first spherical capture is closer to the center point than the second spherical capture.

At S250, a realtime object is rendered. In an embodiment, a plurality of realtime objects are rendered. In some embodiments, a realtime object is an object which is not a pre-rendered object. In an embodiment, a realtime object occludes a prerendered object, casts a shadow on a prerendered object, and the like. In certain embodiments, the prerendered objects, backgrounds, etc. occlude, cast a shadow, and the like, on a realtime object.

In an embodiment, a fragment shader, an occlusion shader, and the like, is configured to output a rendered object, for example by determining pixel color values based on an input of a realtime object and a pre-rendered object.

FIG. 3 is an example schematic diagram of a graphical processing unit (GPU) pipeline for rendering a virtual reality scene, utilized to describe an embodiment. In an embodiment, background data 301 and object data 302 are provided to a graphical processing unit 303 for processing and rendering. In some embodiments, object data 302 includes a texture map, an image, a three-dimensional model, a spherical capture, a depth value, a combination thereof, and the like.

In an embodiment, object data 302 includes objects rendered in real-time. In some embodiments, background data 301 includes a background, an object, a combination thereof, and the like, which are pre-rendered.

In an embodiment, the GPU 303 includes a memory, such as a scratchpad memory, a non-volatile memory, an on-chip memory, an off-chip memory, a combination thereof, and the like. In an embodiment, the GPU 303 utilizes the memory to store thereon pre-rendered images.

For example, in an embodiment, the GPU 303 is configured to pre-render the background image 310. In some embodiments, the GPU 303 is configured to receive a pre-rendered background image.

In certain embodiments, the GPU 303 is configured to receive object data 302, and render a graphical object in real time, based on the received object data 302. In certain embodiments, the GPU 303 is further configured to render the graphical object based on the received object data 302, a viewpoint location of a user, a planar projection, a combination thereof, and the like.

In some embodiments, a plurality of graphical objects, including a background, an object, an object effect, a combination thereof, and the like, are provided to a fragment shader 304. In an embodiment, the fragment shader 304 is configured to render an image for a display, a plurality of displays, and the like. In some embodiments, the fragment shader 304 includes an occlusion fragment shader, utilized to determine if a first pixel is of a first object is occluded by a second pixel of a second object.

In certain embodiments, the fragment shader 304 is configured to determine a shadow value, for example based on a first object. In some embodiments, the shadow value is applied to a second object, and the second object is rendered with the shadow value.

In an embodiment, the occlusion fragment shader 304 is configured to receive a plurality of objects, determine for each object a depth of the object, and render an image based on the depth of each object, such that a first object which is occluded behind a second object is not rendered, wherein the second object is rendered for display. In some embodiments, the occlusion fragment shader 304 is provided with depth information, color information, alpha channel information, a combination thereof, and the like.

In certain embodiments, the GPU 303 is configured to render an image for each display of a plurality of displays, such as a first display 305 and a second display 306. In an embodiment, the first display 305 is configured to display a first stereoscopic image, and a second display 306 is configured to display a second stereoscopic image, such that when a user views the first display 305 and the second display 306, a depth illusion occurs, providing the user with a sensation that they are viewing a three dimensional scene.

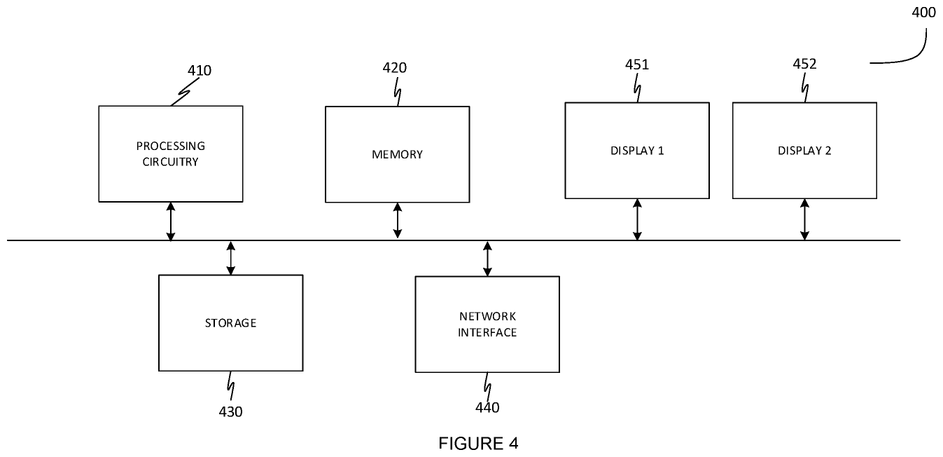

FIG. 4 is an example schematic diagram for a system 400 according to an embodiment. The system 400 includes a processing circuitry 410 coupled to a memory 420, a storage 430, and a network interface 440, and a pair of displays, for example a first display 451 and a second display 452. In an embodiment, the components of the system 400 may be communicatively connected via a bus 460.

The processing circuitry 410 may be realized as one or more hardware logic components and circuits. For example, and without limitation, illustrative types of hardware logic components that can be used include field programmable gate arrays (FPGAs), application-specific integrated circuits (ASICs), Application-specific standard products (ASSPs), system-on-a-chip systems (SOCs), graphics processing units (GPUs), tensor processing units (TPUs), general-purpose microprocessors, microcontrollers, digital signal processors (DSPs), and the like, or any other hardware logic components that can perform calculations or other manipulations of information.

The memory 420 may be volatile (e.g., random access memory, etc.), non-volatile (e.g., read only memory, flash memory, etc.), or a combination thereof. In an embodiment, the memory 420 is an on-chip memory, an off-chip memory, a combination thereof, and the like. In certain embodiments, the memory 420 is a scratch-pad memory for the processing circuitry 410.

In one configuration, software for implementing one or more embodiments disclosed herein may be stored in the storage 430, in the memory 420, in a combination thereof, and the like. Software shall be construed broadly to mean any type of instructions, whether referred to as software, firmware, middleware, microcode, hardware description language, or otherwise. Instructions may include code (e.g., in source code format, binary code format, executable code format, or any other suitable format of code). The instructions, when executed by the processing circuitry 410, cause the processing circuitry 410 to perform the various processes described herein.

The storage 430 is a magnetic storage, an optical storage, a solid-state storage, a combination thereof, and the like, and is realized, according to an embodiment, as a flash memory, as a hard-disk drive, or other memory technology, or any other medium which can be used to store the desired information.

The network interface 440 is configured to provide the system 400 with communication with, for example, the internet.

In an embodiment, the first display 451 and the second display 452 are utilized as a single display element, such that a portion of the display is visible only to a first eye of a user, and a second portion of the display is visible only to a second eye of the user.

It should be understood that the embodiments described herein are not limited to the specific architecture illustrated in FIG. 4, and other architectures may be equally used without departing from the scope of the disclosed embodiments.

All examples and conditional language recited herein are intended for pedagogical purposes to aid the reader in understanding the principles of the disclosed embodiment and the concepts contributed by the inventor to furthering the art, and are to be construed as being without limitation to such specifically recited examples and conditions. Moreover, all statements herein reciting principles, aspects, and embodiments of the disclosed embodiments, as well as specific examples thereof, are intended to encompass both structural and functional equivalents thereof. Additionally, it is intended that such equivalents include both currently known equivalents as well as equivalents developed in the future, i.e., any elements developed that perform the same function, regardless of structure.

It should be understood that any reference to an element herein using a designation such as “first,” “second,” and so forth does not generally limit the quantity or order of those elements. Rather, these designations are generally used herein as a convenient method of distinguishing between two or more elements or instances of an element. Thus, a reference to first and second elements does not mean that only two elements may be employed there or that the first element must precede the second element in some manner. Also, unless stated otherwise, a set of elements comprises one or more elements.

As used herein, the phrase “at least one of” followed by a listing of items means that any of the listed items can be utilized individually, or any combination of two or more of the listed items can be utilized. For example, if a system is described as including “at least one of A, B, and C,” the system can include A alone; B alone; C alone; 2A; 2B; 2C; 3A; A and B in combination; B and C in combination; A and C in combination; A, B, and C in combination; 2A and C in combination; A, 3B, and 2C in combination; and the like.

What is claimed is:

1. A method for rendering a stereoscopic virtual reality environment, comprising:
receiving a digital three dimensional environment, the digital three dimensional environment including a plurality of graphic objects;
selecting a first location in the digital three dimensional environment, the first location represented by a set of unique coordinates;
determining a first spherical projection plane from the first location;
pre-rendering a first object of the plurality of graphic objects on the first spherical projection plane;
rendering in real-time a second object of the plurality of graphic; and
updating a framebuffer with the second object and the first object, based on a shader output.

2. The method of claim 1, further comprising:
determining a second spherical projection plane from the first location, wherein the second spherical projection plane is closer than the first spherical projection to the first location; and
rendering a third object on the second spherical projection plane.

3. The method of claim 1, further comprising:
pre-rendering the first object as a texture map projected onto the first spherical projection plane.

4. The method of claim 1, further comprising:
providing depth information of the second object to a shader processing circuitry; and
configuring the shader processing circuitry to determine occlusion of the second object based on depth information of the first spherical projection plane.

5. The method of claim 1, further comprising:
providing depth information of the second object to a shader processing circuitry; and
configuring the shader processing circuitry to determine a shadow of the second object based on depth information of the first spherical projection plane.

6. The method of claim 1, further comprising:
determining a third spherical projection plane between the first spherical projection plane and a second spherical projection plane;
rendering in real-time a third object of the plurality of graphic objects;
configuring a shader processing circuitry to determine a second shader output based on the third object, the second object, the first object; and
updating the framebuffer based on the second shader output.

7. The method of claim 6, further comprising:
generating a composite rendered scene from the totality of objects rendered in each of the three spherical projection planes.

8. The method of claim 7, further comprising:
rotating the composite rendered environment around the first location, in real-time.

9. The method of claim 6, further comprising:
determining a plurality of third spherical projection planes; and
rendering at least an object of the plurality of graphic objects on a spherical projection plane of the plurality of third spherical projection planes.

10. A non-transitory computer-readable medium storing a set of instructions for rendering a stereoscopic virtual reality environment, the set of instructions comprising:
one or more instructions that, when executed by one or more processors of a device, cause the device to:
receive a digital three dimensional environment, the digital three dimensional environment including a plurality of graphic objects;
select a first location in the digital three dimensional environment, the first location represented by a set of unique coordinates;
determine a first spherical projection plane from the first location;
pre-render a first object of the plurality of graphic objects on the first spherical projection plane;
render in real-time a second object of the plurality of graphic; and
update a framebuffer with the second object and the first object, based on a shader output.

11. A system for rendering a stereoscopic virtual reality environment comprising:
a processing circuitry;
a memory, the memory containing instructions that, when executed by the processing circuitry, configure the system to:
receive a digital three dimensional environment, the digital three dimensional environment including a plurality of graphic objects;
select a first location in the digital three dimensional environment, the first location represented by a set of unique coordinates;
determine a first spherical projection plane from the first location;
pre-render a first object of the plurality of graphic objects on the first spherical projection plane;
render in real-time a second object of the plurality of graphic; and
update a framebuffer with the second object and the first object, based on a shader output.

12. The system of claim 11, wherein the memory contains further instructions which when executed by the processing circuitry further configure the system to:
determine a second spherical projection plane from the first location, wherein the second spherical projection plane is closer than the first spherical projection to the first location; and
render a third object on the second spherical projection plane.

13. The system of claim 11, wherein the memory contains further instructions which when executed by the processing circuitry further configure the system to:
pre-render the first object as a texture map projected onto the first spherical projection plane.

14. The system of claim 11, wherein the memory contains further instructions which when executed by the processing circuitry further configure the system to:
provide depth information of the second object to a shader processing circuitry; and
configure the shader processing circuitry to determine occlusion of the second object based on depth information of the first spherical projection plane.

15. The system of claim 11, wherein the memory contains further instructions which when executed by the processing circuitry further configure the system to:
provide depth information of the second object to a shader processing circuitry; and
configure the shader processing circuitry to determine a shadow of the second object based on depth information of the first spherical projection plane.

16. The system of claim 11, wherein the memory contains further instructions which when executed by the processing circuitry further configure the system to:
determine a third spherical projection plane between the first spherical projection plane and a second spherical projection plane;
render in real-time a third object of the plurality of graphic objects;
configure a shader processing circuitry to determine a second shader output based on the third object, the second object, the first object; and
update the framebuffer based on the second shader output.

17. The system of claim 16, wherein the memory contains further instructions which when executed by the processing circuitry further configure the system to:
generate a composite rendered scene from the totality of objects rendered in each of the three spherical projection planes.

18. The system of claim 17, wherein the memory contains further instructions which when executed by the processing circuitry further configure the system to:
rotate the composite rendered environment around the first location, in real-time.

19. The system of claim 16, wherein the memory contains further instructions which when executed by the processing circuitry further configure the system to:
determine a plurality of third spherical projection planes; and
render at least an object of the plurality of graphic objects on a spherical projection plane of the plurality of third spherical projection planes.
